(19) United States
(12) Patent Application Publication
(10) Pub. No.: US 2009/0022310 A1
(43) Pub. Date: Jan. 22, 2009

(54) CRYPTOGRAPHIC DEVICE AND METHOD FOR GENERATING PSEUDO-RANDOM NUMBERS

(75) Inventor: Matt Robshaw, Paris (FR)

Correspondence Address: OBLON, SPIVAK, MCCLELLAND MAIER & NEUSTADT, P.C., 1940 DUKE STREET, ALEXANDRIA, VA, 22314, US

(73) Assignee: France Telecom, Paris (FR)

(21) Appl. No.: 12/278,583

(22) PCT Filed: Feb. 1, 2007
(86) PCT No.: PCT/FR07/50725

§ 371 Date: Aug. 7, 2008

(30) Foreign Application Priority Data
Feb. 13, 2006 (FR) 0650506

(51) Int. Cl. H04L 9/28

(52) U.S. Cl. 380/28

(57) ABSTRACT

A cryptographic device and a cryptographic method of generating pseudo-random numbers. Initial data is divided into a plurality of words on b bits defined in a finite body GF(2^{b}). The words are assigned to cells of a state table to form an initial state block. The cells of the state table are grouped to assign a group of cells to each set of d/b words, where d is a multiple of b strictly greater than b. And, a succession of state blocks is iteratively generated from the initial state block to form a final state block, so that on each iteration each set of d/b words of a current state block is replaced by another set of d/b words to form a next state block using a reference table including substitution elements on d bits.

### TECHNICAL FIELD OF THE INVENTION

The invention relates to cryptography. To be more precise, the invention concerns a scheme for generating pseudo-random numbers that can be used in devices of low computation power. The technique of the invention can be applied to implementing a low-cost pseudo-random number generator (PRNG).

### BACKGROUND OF THE INVENTION

Generally speaking, there are two approaches to designing symmetrical cryptography algorithms.

The first approach provides a “proof of security” based on the relationship between a method of “breaking” a code and the capacity to solve what is generally considered to be a difficult problem.

The second and more common approach depends on precisely engineering an electronic circuit including logic gate components to effect encryption to the required security level. Under such circumstances, efficacy can be quantified by the computation speed or the number of logic gates necessary to implement the electronic circuit.

At present, following standardization (FIPS 197, NIST 2001) of Advanced Encryption Standard (AES) cryptography algorithms, it is very beneficial to implement such algorithms in a wide range of applications.

The AES algorithm is noteworthy for its close compliance with the Shannon principles known in the art and with two concepts that are important for implementing cryptography algorithms, namely “confusion” and “diffusion”. Putting it simply, confusion corresponds to the idea of “performing difficult operations” and diffusion corresponds to the idea of “causing the change or transformation to propagate” during a cryptography calculation.

It is usually considered that one of the best ways to obtain a confusion effect is to use a substitution box (S-box), and that one of the best ways to produce a diffusion effect is to perform a certain kind of permutation.

The input to an AES algorithm is a block of 16 bytes. Each byte is replaced by another byte specified by an 8-bit to 8-bit S-box. These bytes are then placed in a matrix in which each element of the matrix is shifted cyclically to the left by a certain number of columns. A matrix product is then computed before adding each byte to a byte corresponding to a round key obtained by diversifying an encryption key.

Thus the security of an AES algorithm depends on interaction between the S-box and a mixing (or diffusion) operation that permutates the bytes and combines them structurally. Precise interaction between the bytes produces and guarantees good resistance to differential cryptanalysis and linear cryptanalysis attacks.

At present, attempts are being made to introduce cryptography functions into very restricted computation environments, for example into RFID chips.

However, algorithms for such environments are produced on a one-off basis and use cryptography components of low capacity. It is very difficult to produce cryptography components having quality comparable to those used to implement an AES algorithm in an environment where computation is highly restricted.

### OBJECT AND SUMMARY OF THE INVENTION

The present invention provides a cryptographic method of generating pseudo-random numbers that comprises the following steps:
dividing initial data into a plurality of words on b bits defined in a finite body GF(2^{b});
assigning said words to cells of a state table to form an initial state block;
grouping the cells of said state table to assign a group of cells to each set of d/b words, where d is a multiple of b strictly greater than b; and
generating a succession of state blocks iteratively from said initial state block to form a final state block, so that on each iteration each set of d/b words of a current state block is replaced by another set of d/b words to form a next state block using a reference table including substitution elements on d bits.

Using a reference table having elements of length d strictly greatly than b introduces a diffusion effect in addition to the confusion effect, thereby achieving high quality generation of pseudo-random numbers at very low computation cost.

Note that an AES algorithm uses an S-box having elements of the same size as the words of an internal state block, causing an input word on b bits to correspond to an output word on b bits, and the words are used one by one. Thus in such algorithms replacing words by substitution as specified by the S-box generates a confusion effect but no diffusion effect.

In contrast, the substitution operation as specified by the reference table of the invention does not use the words one by one, but in groups. Moreover, note that using a reference table or S-box having elements larger than the internal state words goes entirely against the customary approach of the person skilled in the art.

Thus the configuration of the invention provides both diffusion and confusion effects whilst economizing on computation time for the same level of security. This raises the level of security at the same time as reducing the number of logic gates (known as the gates equivalent (GE)) used in an electronic circuit implementing this encryption method. Thus the technique of the invention can easily be applied to implementing a low-cost pseudo-random number generator in a very restricted environment such as in an RFID chip or cell. Furthermore, this technique can be applied to a variety of cryptography algorithm types: block coding, stream coding, hashing functions, message authentication codes. Moreover, using such reference tables with d strictly greater than b produces a pseudo-random number generator that is more robust against cryptanalysis attacks known as square attacks, to which AES-type algorithms are reputed to be sensitive.

Iterative generation of said succession of state blocks advantageously further comprises a step of mixing the words of said current state block in accordance with a predetermined mixing transformation.

This mixing transformation guarantees better diffusion or propagation of the bits of a state block, thus enhancing the security of encryption and the quality of the pseudo-random numbers generated without overburdening the computation steps.

This predetermined mixing transformation can include multiplication in the finite body GF(2^{b}) of a column of said current state block by a predefined matrix in said finite body. This matrix multiplication is a linear transformation that is relatively simple to implement.

Iterative generation of said succession of state blocks advantageously further comprises permutation of words over at least a portion of said current state block.

This further increases the propagation of the bits, which improves security.

According to one feature of the present invention, iterative generation of a succession of state blocks further comprises modification of at least part of a word situated in a predetermined cell of the state table.

This reduces any symmetry that might occur on successive iterations, which complicates any prediction attempt and consequently improves the security of the method.

According to another feature of the present invention, the method includes adding each word of said initial state block in the finite body to a corresponding word in an encryption key, thereby improving security.

Thus security similar to that of an AES algorithm can be guaranteed with an optimum number of computations.

Said initial data is advantageously generated by a counter. Thus pseudo-random numbers can easily be generated with a minimum number of operations.

The invention is also directed to a cryptographic device for generating pseudo-random numbers, the device comprising:
division means for dividing initial data into a plurality of words on b bits defined in a finite body GF (2^{b});
assignment means for assigning said words to cells of a state table to form an initial state block;
definition means for defining and storing a reference table including substitution elements on d bits where d is a multiple of b strictly greater than b;
grouping means for grouping the cells of said state table to assign a group of cells to each set of d/b words; and
generating means for generating a succession of state blocks iteratively from said initial state block to form a final state block, so that on each iteration each set of d/b words of a current state block is replaced by another set of d/b words as a function of said reference table to form a next state block.

The invention is also directed to a pseudo-random number generator including a counter and logic gates for implementing the method briefly described above.

The invention is further directed to an RFID device including a generator as briefly described above.

### BRIEF DESCRIPTION OF THE DRAWINGS

Other features and advantages of the invention emerge on reading the description given below by way of non-limiting example and with reference to the appended drawings, in which:

FIG. 1 is a chart showing the steps of a cryptography method of the invention;

FIG. 2 illustrates one example of the action of a reference table in the FIG. 1 method;

FIG. 3 is a very diagrammatic illustration of a device implementing the FIG. 1 method;

FIG. 4 shows one particular embodiment of the FIG. 1 method; and

FIG. 5 is a very diagrammatic illustration of a pseudo-random generator implementing the FIG. 4 method.

### DETAILED DESCRIPTION OF EMBODIMENTS

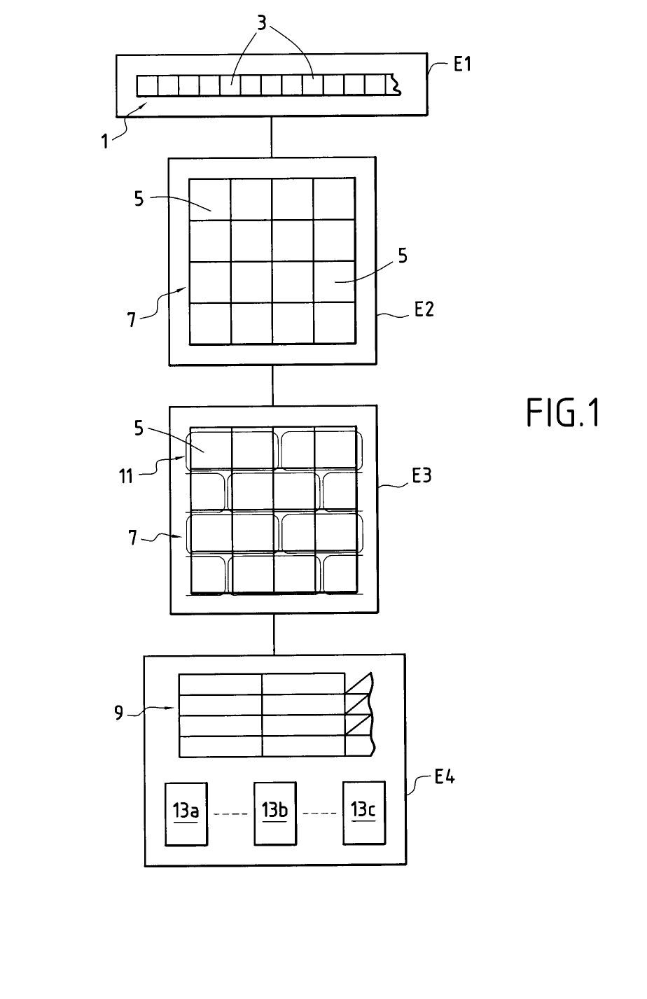

FIG. 1 is a chart showing the steps of a cryptography method of the invention for generating pseudo-random numbers from initial data.

The step E1 divides the message or the initial data 1 into words 3 on b bits defined in a finite body GF(2^{b}), where b can be equal to 2, 4, 8, 16, 32, 64 or 128, for example.

In the step E2, these words 3 are assigned to cells 5 of a state table 7 to form an initial state block. Note that only some of the words 3 can be placed in the state table 7.

In the step E3, the cells 5 from the state table 7 are grouped to assign a group 11 of cells to each cell of d/b words, where d is a multiple of b, with d>b. Each set of words then corresponds to an element on d bits.

Finally, in the step E4, a succession of current state blocks 13b is generated iteratively from the initial state block 13a to form a last block or final state block 13c using a predefined reference or substitution table 9 including substitution elements on d bits. Thus the reference table 9 can replace an input element on d bits by an output element on d bits.

On each iteration, each set of d/b words of a current state block 13b is replaced by another set of d/b words as a function of the reference table 9 to form a next state block. Thus the final state block 13c represents the pseudo-random number generated.

Using a reference table having elements of length d>b introduces a diffusion effect in addition to the confusion effect and achieves a good level of security faster than a prior art substitution table (S-box) with d=b.

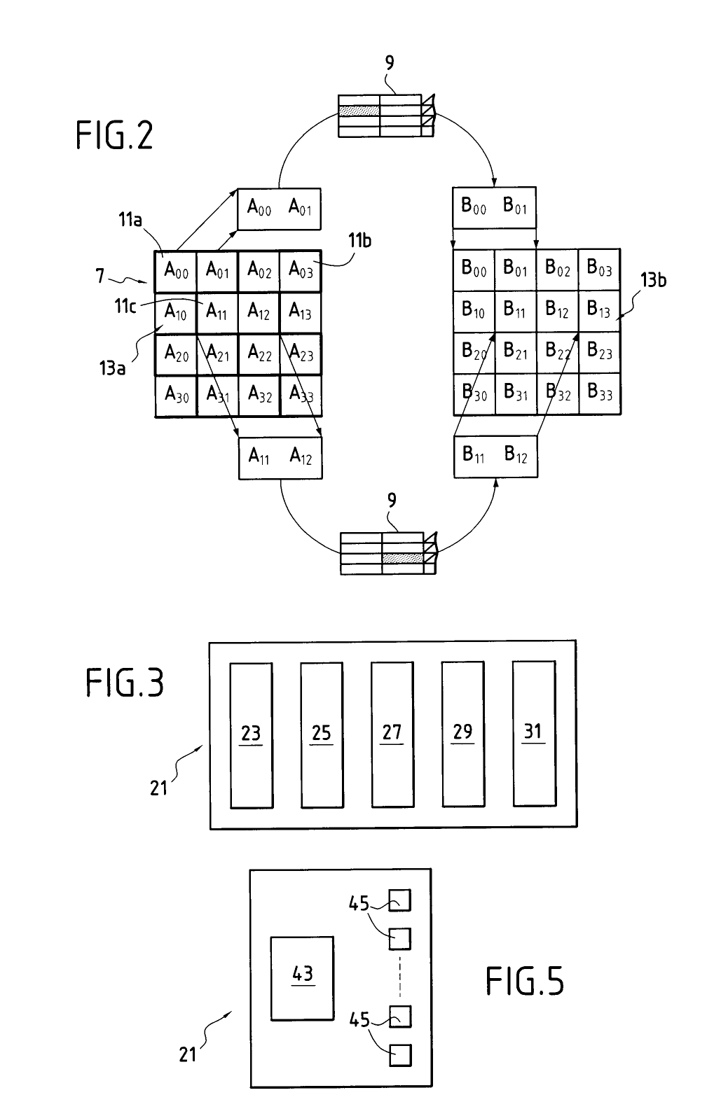

FIG. 2 illustrates one example of the action of a reference table 9 on a state table 7 comprising four columns and four rows (4×4). In this example the initial state block 13a includes words A₀₀, . . . , A₃₃ on 4 bits (i.e. b=4) and the reference table 9 includes elements on 8 bits (i.e. d=8). In this example, an S-box reference table of an AES algorithm can be used.

Thus the cells 5 of the state table 7 are grouped in pairs. In this example, the cells 5 including the words A₀₀ and A₀₁ form a first group 11a, those containing the words A₀₂ and A₀₃ form a second group 11b, those containing the words A₁₁ and A₁₂ form a third group 11c, and so on. In this example, the reference table 9 substitutes the words two by two. For example, the words A₀₀ and A₀₁ are replaced by B₀₀ and B₀₁ and the words A₀₂ and A₀₃ are replaced by B₀₂ and B₀₃. Another state block 13b is therefore formed containing the words B₀₀, . . . , B₃₃ defined by a function “S” determined by the reference table 9 in the following manner, where the symbol “∥” between two words represents their concatenation:

B₀₀∥B₀₁=S[A₀₀∥A₀₁], B₀₂∥B₀₃=S[A₀₂∥A₀₃]

B₁₁∥B₁₂=S[A₁₁∥A₁₂], B₁₃∥B₁₀=S[A₁₃∥A₁₀]

B₂₀∥B₂₁=S[A₂₀∥A₂₁], B₂₂∥B₂₃=S[A₂₂∥A₂₃]

B₃₁∥B₃₂=S[A₃₁∥A₃₂], B₃₃∥B₃₀=S[A₃₃∥A₃₀]

Thus a succession of state blocks 13b can be generated iteratively as a function of one or more reference tables 9. Note that in a restricted (for example RFID) medium, it is preferable (although not mandatory) to use a single reference table 9 for all operations.

To guarantee improved propagation, the words 3 of a current state block 13b can be mixed using a predetermined transformation “MIX”.

Thus on each iteration, substitution as a function of the reference table 9 can be followed by mixing words on b bits, for example using a technique similar to that used by the AES algorithm.

In the FIG. 2 example, this mixing operation MIX can be effected in the following manner:

C₀₀∥C₁₀∥C₂₀∥C₃₀=MIX [B₀₀∥B₁₀∥B₂₀∥B₃₀]

C₀₁∥C₁₁∥C₂₁∥C₃₁=MIX [B₀₁∥B₁₁∥B₂₁∥B₃₁]

C₀₂∥C₁₂∥C₂₂∥C₃₂=MIX [B₀₂∥B₁₂∥B₂₂∥B₃₂]

C₀₃∥C₁₃∥C₂₃∥C₃₃=MIX [B₀₃∥B₁₃∥B₂₃∥B₃₃]

Depending on the properties of the mixing operation MIX, which themselves depend on the matrices chosen, it can be advantageous to permutate words 3 over at least a portion of the current state block 13b by means of a permutation operation “Swap”.

In the FIG. 2 example, this permutation Swap can be effected in the following manner:

Swap C₀₂∥C₁₂ with C₂₂∥C₃₂

Swap C₀₃∥C₁₃ with C₂₃∥C₃₃

Furthermore, depending on the characteristics of the electronic components used to fabricate a device implementing the method of the invention, a simple incrementation counter or any other similar mechanism can be used to reduce any symmetry that might occur during successive iterations. For example, this can involve a simple modification of at least part of a word in a predetermined cell 5 of the state table 7. For example, it suffices to complement a few bits situated in a clearly defined single cell 5 at a clearly defined moment of the computation.

Moreover, the method of the invention can include combination by adding, using the exclusive-OR operation, each word 3 of the initial state block 13a in the finite body to a corresponding word of a predefined encryption key or to alternating sequences of secret words.

FIG. 3 shows very diagrammatically a device 21 implementing the FIG. 1 method. This device 21 includes division means 23, assignment means 25, definition means 27, grouping means 29, and generation means 31.

The division means 23 divide the message or the initial data into words 3 on b bits. The assignment means 25 assign these words 3 to the cells 5 of the state table 7 to form the initial state block 13a. The defining means 27 define and store the reference(s) of substitution table(s) 9 containing substitution elements on d bits, where d>b. The grouping means 29 group the cells 5 of the state table to assign a group 11 of cells to each set of d/b words. The generation means 31 generate a succession of state blocks 13b iteratively from the initial state block 13a to form a final state block 13c representing a pseudo-random number.

To implement a pseudo-random number generator, the initial data 1 used to form the initial state block 13a can be generated by a simple counter.

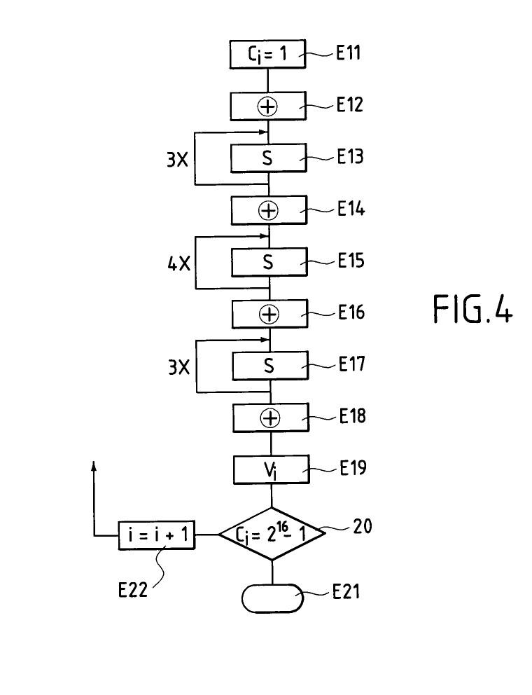

FIG. 4 is a chart showing one particular embodiment of a 64-bit pseudo-random number generator PRNG using ten iterations. This generator can be used in an RFID chip containing a 128-bit secret key that can be represented by a pair of data items (s₀, s₁), for example, where s₀ and s₁ both have a length of 64 bits.

In each sequence of iterations defined by a 16-bit counter cᵢ, a 64-bit output value vᵢ is generated by the PRNG as a function of cᵢ, s₀ and s₁ (i.e. vᵢ=f(cᵢ, s₀, s₁) for 1≦i≦2¹⁶).

The step E11 is the initial state of a sequence of iterations (counter cᵢ=1). In this step, the 64 bits of the initial data 1 are arranged in a 4×4 state table 7 containing sixteen words A₀₀, . . . , A₃₃ on four bits, as shown in the FIG. 2 example.

In the step E12, the first row of the state table 7 is added (using the exclusive-OR operation) to the current value of the counter arranged as 4×4 bits, i.e. cᵢ=[cᵢ₀∥cᵢ₁∥cᵢ₂∥cᵢ₃].

Three iterations “Mixtable” are carried out in the step E13. Each iteration Mixtable includes substitutions in accordance with a function S determined by a reference table 9 performing 8-bit permutations (for example an AES S-box) and/or mixing operations MIX within one or more columns and/or permutations Swap.

On a given iteration number r, the current state block 13b is defined as follows as a function of the reference table 9:

B₀₀∥B₀₁=S[A₀₀∥A₀₁], B₀₂∥B₀₃=S[A₀₂∥A₀₃]

B₁₁∥B₁₂=S[A₁₁∥A₁₂], B₁₃∥B₁₀=S[A₁₃∥A₁₀]

B₂₀∥B₂₁=S[A₂₀∥A₂₁], B₂₂∥B₂₃=S[A₂₂∥A₂₃]

B₂₁∥B₃₂=S[A₃₁∥A₃₂⊕r], B₃₃∥B₃₀=S[A₃₃∥A₃₀]

Note that on iteration r, the value taken by r is added to a word (for example the word A₃₂) in order to reduce any symmetry effect that might occur between iterations.

The mixing operation MIX performs mixing within a column using a predetermined 4×4 matrix M in a finite body GF(2⁴) . This operation multiplies each column of the state table (7) by this matrix M.

The mixing operation MIX can be followed by permutation of the words on the last two rows of the current state block 13b in the following manner:

C₀₂∥C₁₂ is swapped with C₂₂∥C₃₂; and

C₀₃∥C₁₃ is swapped with C₂₃∥C₃₃.

The step E14 combines by means of an exclusive-OR operation the 64 bits of the current state block 13b with the 16 half-bytes (16×4 bits) of the secret key in s₁.

The step E15 performs four further iterations Mixtable.

The step E16 combines by means of an exclusive-OR operation the 64 bits of the current state block 13b with the 16 half-bytes (16×4 bits) of the secret key in s₀.

The step E17 performs three further iterations Mixtable.

The step E18 combines by means of an exclusive-OR operation the 64 bits of the current state block 13b with the 16 half-bytes (4 bits) of the secret key in s₁.

The step E19 gives the output value vᵢ on the i^{th} sequence of iterations in the following manner:

Vᵢ=[V₀₀∥ . . . ∥V₀₃∥V₁₀∥ . . . ∥V₁₃∥ . . . ∥V₃₃].

The step E20 is a test to verify if the value cᵢ of the counter is equal to (2¹⁶−1). If yes, the chip is destroyed in the step E21; if no, cᵢ is incremented in the step E22 before starting the above steps again.

FIG. 5 shows very diagrammatically a pseudo-random number generator (PRNG) 41 implementing the FIG. 4 method. This generator 41 includes a counter 43 and logic gates 45 and can easily be implemented in an RFID chip.

Note that one particular implementation of an AES algorithm determined by an S-box and a random access memory (RAM) requires 395 and 2337 logic gates, respectively.

In contrast, by comparison with the AES algorithm, a PRNG 41 according to FIGS. 4 and 5 halves the number of states and does not include iteration keys obtained by diversification. Moreover, the mixing operations within columns require very few logic gates.

There is therefore obtained, by means of the invention, an efficient PRNG 41 with a good security level and a reduced number of gates compared to the AES algorithm.

1-10. (canceled)

11. A cryptographic method of generating pseudo-random numbers, comprising:
dividing initial data into a plurality of words on b bits defined in a finite body GF(2^{b});
assigning the words to cells of a state table to form an initial state block;
grouping the cells of the state table to assign a group of cells to each set of d/b words, wherein d is a multiple of b strictly greater than b; and
generating a succession of state blocks iteratively from the initial state block to form a final state block representative of a pseudo-random number, so that on each iteration each set of d/b words of a current state block is replaced by another set of d/b words to form a next state block using a reference table including substitution elements on d bits.

12. A method according to claim 11, wherein the iterative generation of the succession of state blocks further comprises mixing the words of the current state block in accordance with a predetermined mixing transformation.

13. A method according to claim 12, wherein the predetermined mixing transformation includes multiplication in the finite body GF(2b) of a column of the current state block by a predefined matrix in the finite body.

14. A method according to claim 11, wherein the iterative generation of the succession of state blocks further comprises permutation of words over at least a portion of said current state block.

15. A method according to claim 11, wherein the iterative generation of a succession of state blocks further comprises modification of at least part of a word situated in a predetermined cell of the state table.

16. A method according to claim 11, further comprising adding each word of the initial state block in the finite body to a corresponding word in an encryption key.

17. A method according to claim 11, wherein the initial data is generated by a counter.

18. A cryptographic device for generating pseudo-random numbers, comprising:
division means for dividing initial data into a plurality of words on b bits defined in a finite body GF(2^{b});
assignment means for assigning the words to cells of a state table to form an initial state block;
definition means for defining and storing a reference table including substitution elements on d bits where d is a multiple of b strictly greater than b;
grouping means for grouping the cells of the state table to assign a group of cells to each set of d/b words; and
generating means for generating a succession of state blocks iteratively from the initial state block to form a final state block, so that on each iteration each set of d/b words of a current state block is replaced by another set of d/b words as a function of a reference table to form a next state block.

19. A device according to claim 18, further comprising a counter and logic gates.

20. An RFID device including the device according to claim 19.
